(19) United States
(12) Patent Application Publication
(10) Pub. No.: US 2023/0216252 A1
(43) Pub. Date: Jul. 6, 2023

(54) Universal Serial Bus (USB) Cable

(71) Applicant: Wei-Feng Zhou, Hong Kong (CN)

(72) Inventor: Wei-Feng Zhou, Hong Kong (CN)

(21) Appl. No.: 17/569,538

(22) Filed: Jan. 6, 2022

(51) Int. Cl. H01R 13/72; H01R 31/06

(52) U.S. Cl. CPC H01R 13/72; H01R 31/065

(57) ABSTRACT

A universal serial bus (USB) cable contains: a body. The body includes a first cap, a second cap, and at least one locating disc. An accommodation case includes a first cover, a roller, a printed circuit board (PCB), an engagement sheet, and a second cover. The roller is connected with a retractable cable, and the retractable cable is connected with a charger connector. The PCB is connected with a first end of a wire, and a second end of the wire is connected with an electric connector. The second cover has an accommodating chamber for receiving the roller, the PCB, and the engagement sheet. The first cover is connected with the second cover. A protection member has a detachable adapter received therein. The charger connector of the retractable cable is accommodated in the protection member, and the accommodation case is received in the receiving space of the body.

### FIELD OF THE INVENTION

The present invention relates to a universal serial bus (USB) cable which is fixed on a backpack, a school bag or a briefcase and contains a protection member to protect the charger connector and to enhance discharging convenience.

### BACKGROUND OF THE INVENTION

In the current situation of rapid changes in technology products, carrying mobile power devices and universal serial bus (USB) cables for charging, connecting and transferring data of portable electronic products such as laptops, tablets, smart phones, etc. has become a part of daily life.

However, in use, taking a smart phone for an example, when one end of the universal serial bus (USB) cable is connected to the smart phone and the other end of the USB is connected to the mobile power device for charging, holding both of them in your hand will not only have a certain weight, but also be quite inconvenient to use; When the mobile power device is placed in a backpack, schoolbag, briefcase, etc., the USB cable is easily entangled and knotted, the backpack cannot be completely closed due to the extension of the USB cable, or other problems, causing inconvenience to the user.

The present invention has arisen to mitigate and/or obviate the afore-described disadvantages.

### SUMMARY OF THE INVENTION

One aspect of the present invention is to provide a universal serial bus (USB) which is fixed on a backpack, a school bag or a briefcase.

Another aspect of the present invention is to provide a universal serial bus (USB) which is capable of protecting the charger connector and the detachable adapter and to enhance discharging convenience.

To obtain the above aspects, a universal serial bus (USB) cable provided by the present invention contains: a body, and the body includes a first cap, a second cap, and at least one locating disc.

The first cap is connected with the second cap, a receiving space is defined between the first cap and the second cap of the body, and the locating disc is connected with the second cap.

An accommodation case includes a first cover, a roller, a printed circuit board (PCB), an engagement sheet, and a second cover. The roller is connected with a first end of a retractable cable, and a second end of the retractable cable is connected with a charger connector; the PCB is connected with a first end of a wire, and a second end of the wire is connected with an electric connector; the engagement sheet is elongated; the second cover has an accommodating chamber defined therein. The roller, the PCB, and the engagement sheet are received in the accommodating chamber of the second cover. The first cover is connected with the second cover.

A protection member has a detachable adapter received therein.

The charger connector of the retractable cable of the accommodation case is accommodated in the protection member, and the accommodation case is received in the receiving space of the body.

Preferably, the body is fixed on a backpack, a school bag or a briefcase, by using the at least one locating disc, and the protection member is mounted outside the backpack, the school bag or the briefcase.

Preferably, the retractable cable of the accommodation case has a predetermined length.

Preferably, the charger connector is a Type-C connector.

Preferably, the electric connector is a USB adapter and is electrically connected with an external power supply.

Preferably, the protection member is made of rubber or silicone.

Preferably, the protection member is a square box configured to be opened and closed, and the protection member has at least one trench defined therein and configured to receive the detachable adapter and the charger connector of the accommodation case.

Preferably, the detachable adapter of the protection member is a Lightning/Micro adapter and is fitted on the charger connector of the accommodation case.

### BRIEF DESCRIPTION OF THE DRAWINGS

FIG. 1 is a perspective view showing the assembly of a universal serial bus (USB) according to a preferred embodiment of the present invention.

FIG. 2 is another perspective view showing the assembly of the universal serial bus (USB) according to the preferred embodiment of the present invention.

FIG. 3 is a perspective view showing the exploded components of the universal serial bus (USB) according to the preferred embodiment of the present invention.

FIG. 4 is a perspective view showing the application of the universal serial bus (USB) according to the preferred embodiment of the present invention.

### DETAILED DESCRIPTION OF THE PREFERRED EMBODIMENTS

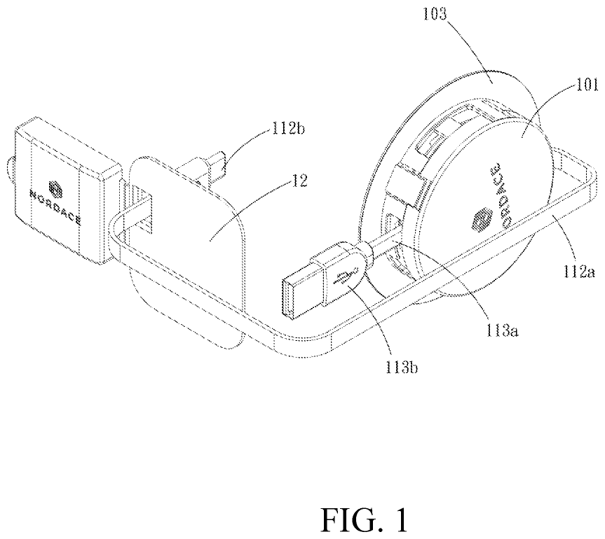

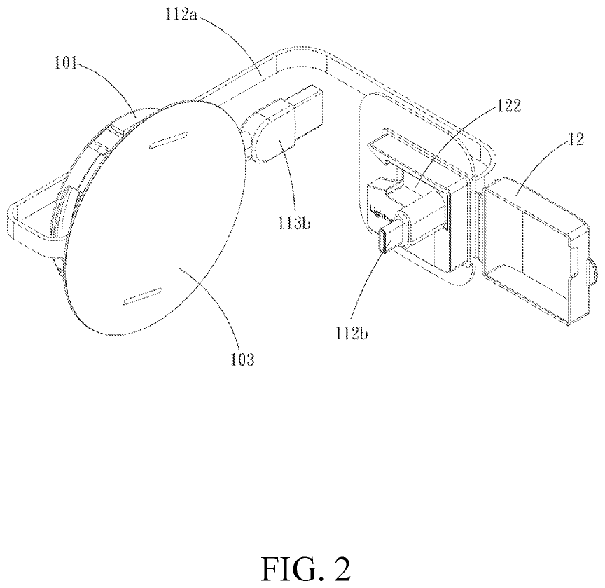

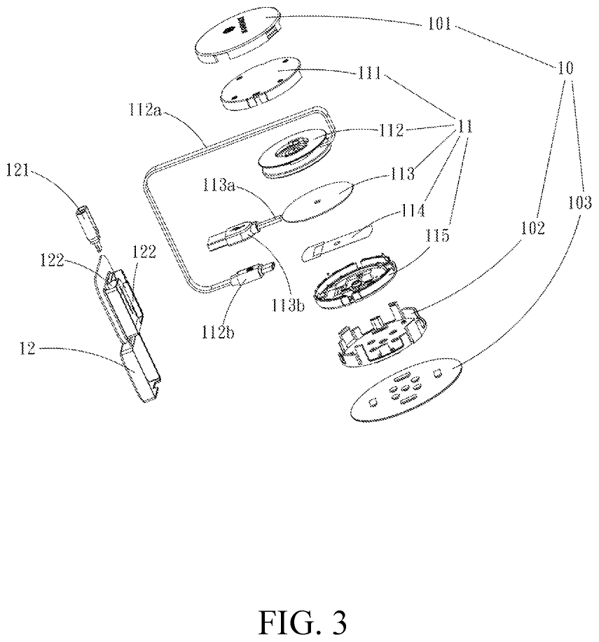

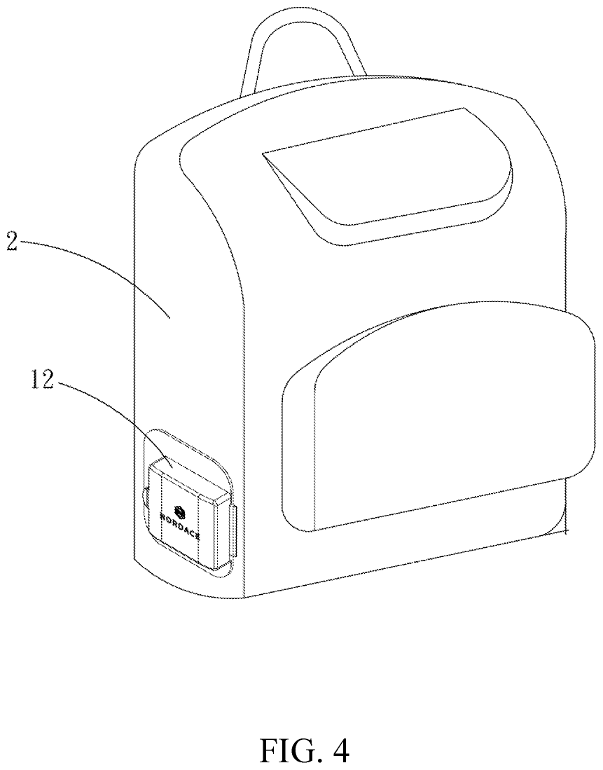

With reference to FIGS. 1-4, a universal serial bus (USB) cable according to a preferred embodiment of the present invention comprises: a body 10, and the body 10 includes a first cap 101, a second cap 102, and at least one locating disc 103.

The first cap 101 is connected with the second cap 102, a receiving space is defined between the first cap 101 and the second cap 102 of the body 10.

An accommodation case 11 includes a first cover 111, a roller 112, a printed circuit board (PCB) 113, an engagement sheet 114, and a second cover 115. The roller 112 is connected with a first end of a retractable cable 112a, and a second end of the retractable cable 112a is connected with a charger connector 112b. The PCB 113 is connected with a first end of a wire 113a, and a second end of the wire 113a is connected with an electric connector 113b. The engagement sheet 114 is elongated. The second cover 115 has an accommodating chamber defined therein, wherein the roller 112, the PCB 113, and the engagement sheet 114 are received in the accommodating chamber of the second cover 115. The first cover 111 is connected with the second cover 115. A protection member 12 has a detachable adapter 121 received therein, wherein the charger connector 112b of the retractable cable 112a of the accommodation case 11 is accommodated in the protection member 12, and the accommodation case 11 is received in the receiving space of the body 10.

The retractable cable 112a of the accommodation case 11 has a predetermined length, the charger connector 112b is a Type-C connector, and the electric connector 113b is a USB adapter and is electrically connected with an external power supply. The protection member 12 is made of rubber or silicone and is a square box configured to be opened and closed. The protection member 12 has at least one trench 122 defined therein and configured to receive the detachable adapter 121 and the charger connector 112b of the accommodation case 11. The detachable adapter 121 of the protection member 12 is a Lightning/Micro adapter and is fitted on the charger connector 112b of the accommodation case 11.

In use, the body 10 is fixed on a backpack 2 by using the at least one locating disc 103, and the protection member 12 is mounted outside the backpack, wherein the external power supply (such as a portable power bank) is accommodated in the backpack 2, and the electric connector 113b of the accommodation case 11 is electrically connected with the external power supply. The protection member 12 is opened so as to remove the charger connector 112b from the accommodation case 11 and to electrically connect the charger connector 112b with a smart phone. Thereby, the length of the retractable cable 112a is adjustably pulled based on using requirements so that the charger connector 112b is electrically connected with the smart phone, thus charging the smart phone.

After charging the smart phone, the retractable cable 112a is retracted, then the charger connector 112b is received in the at least one trench 122 of the protection member 12, thereafter the protection member 12 is closed. Accordingly, the backpack is not opened to charge the smart phone conveniently, and the charger connector 112b does not expose outside the backpack 2, thus protecting the charger connector 112b. Preferably, the at least one trench 122 of the protection member 12 accommodates the detachable adapter 121 to correspond to different device (such as i-phone), thus enhancing using convenience. In addition, a logo or trademark design/figure/device is adhered/printed on the first cap 101 or the protection member 12.

While the preferred embodiments of the invention have been set forth for the purpose of disclosure, modifications of the disclosed embodiments of the invention as well as other embodiments thereof may occur to those skilled in the art. The scope of the claims should not be limited by the preferred embodiments set forth in the examples, but should be given the broadest interpretation consistent with the description as a whole.

What is claimed is:

1. A universal serial bus (USB) cable comprising: a body, and the body includes a first cap, a second cap, and at least one locating disc;
wherein the first cap is connected with the second cap, a receiving space is defined between the first cap and the second cap of the body, and the locating disc is connected with the second cap;
wherein an accommodation case includes a first cover, a roller, a printed circuit board (PCB), an engagement sheet, and a second cover; wherein the roller is connected with a first end of a retractable cable, and a second end of the retractable cable is connected with a charger connector; the PCB is connected with a first end of a wire, and a second end of the wire is connected with an electric connector; the engagement sheet is elongated; the second cover has an accommodating chamber defined therein, wherein the roller, the PCB, and the engagement sheet are received in the accommodating chamber of the second cover; the first cover is connected with the second cover;
wherein a protection member has a detachable adapter received therein;
wherein the charger connector of the retractable cable of the accommodation case is accommodated in the protection member, and the accommodation case is received in the receiving space of the body.

2. The USB cable as claimed in claim 1, wherein the body is fixed on a backpack, a school bag or a briefcase, by using the at least one locating disc, and the protection member is mounted outside the backpack, the school bag or the briefcase.

3. The USB cable as claimed in claim 1, wherein the retractable cable of the accommodation case has a predetermined length.

4. The USB cable as claimed in claim 1, wherein the charger connector is a Type-C connector.

5. The USB cable as claimed in claim 1, wherein the electric connector is a USB adapter and is electrically connected with an external power supply.

6. The USB cable as claimed in claim 1, wherein the protection member is made of rubber or silicone.

7. The USB cable as claimed in claim 1, wherein the protection member is a square box configured to be opened and closed, and the protection member has at least one trench defined therein and configured to receive the detachable adapter and the charger connector of the accommodation case.

8. The USB cable as claimed in claim 1, wherein the detachable adapter of the protection member is a Lightning/Micro adapter and is fitted on the charger connector of the accommodation case.
